(19) United States
(12) Patent Application Publication
(10) Pub. No.: US 2009/0145836 A1
(43) Pub. Date: Jun. 11, 2009

(54) Vibratory separator screens & seals

(76) Inventor: Paul William Dufilho, Willis, TX (US)

Correspondence Address: Guy L. McClung, III, 5315B FM 1960 Road West, # 114, Houston, TX, 77069-4410, US

(21) Appl. No.: 12/001,479

(22) Filed: Dec. 11, 2007

(51) Int. Cl. B01D 33/03; H01S 4/00; B01D 33/54; B01D 35/20

(52) U.S. Cl. 210/388; 29/592; 210/780

(57) ABSTRACT

A seal structure for sealing around the sides of a screen for a vibratory separator, the screen including a support, the support having two spaced-apart support ends and two spaced-apart support sides, screening material on the support, a seal member having ends and sides encompassing ends and sides of the support, the seal member having a bottom part connected to the seal member's two spaced-apart seal ends and the two spaced-apart seal sides, and the bottom member, in one aspect, having a hollow seal portion for sealingly contacting a supporting structure of the vibratory separator for supporting the screen. This Abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### BACKGROUND OF THE INVENTION

1. Field of the Invention

The present invention is directed to screens for shale shakers and vibratory separators; to screens with seals for sealing a screen/mounting-structure interface; to seals for such screens; and to methods for using these things.

2. Description of Related Art

Vibratory separators are used in a wide variety of industries to separate materials such as liquids from solids or solids from solids. In the oil and gas industries, shale shakers use screens to treat drilling fluid contaminated with undesirable solids. Typically such apparatuses have a basket, deck, or other screen holding or mounting structure mounted in or over a receiving receptacle or tank and vibrating apparatus for vibrating one or more screens. Material to be treated is introduced to the screen(s) either by flowing it directly onto the screen(s) or by flowing it into a container, tank, or “possum belly” from which it then flows to the screen(s). To optimize the efficiency and effectiveness of these systems, the screen or screens used to treat material is sealed in place on a screen deck, in a screen basket, or on screen mounting structure.

There are a wide variety of patents disclosing screen assemblies for shale shakers and vibratory separators, including, but not limited to, those in U.S. Pat. Nos. 7,175,028; 6,892,888; 6,543,621; 6,439,392; 6,202,856; 5,967,336; 5,690,826; 5,392,925; 4,909,929; 4,861,462; and in U.S. application Ser. No. 10/473,262 filed Nov. 12, 2002. The prior art discloses a variety of gaskets, seals and seal systems for use with screen of a shale shaker or vibratory separator; including, but not limited to, the disclosures of U.S. Pat. Nos. 7,040,488 (co-owned with the present invention); 6,955,252 (co-owned with the present invention); 6,672,460; 6,543,621; 6,269,954; and U.S. patent applications (both co-owned with the present invention and both disclosing bottom seals or space maintainers that are hollow and, in one aspect, D-shaped) U.S. Ser. No. 10/923,252 filed Aug. 20, 2004 and U.S. Ser. No. 11/063,667 filed Feb. 22, 2005—all incorporated fully herein for all purposes.

### BRIEF SUMMARY OF THE INVENTION

The present invention discloses, in certain aspects, screening assemblies for shale shakers or other vibratory separators which have a screen support; screening material (layer or layers) on the support; and a seal member (or members) around the screen(s) for sealing an interface between the screen and screen mounting structure (deck, basket, etc.). In certain aspects such seal members have a lower seal part locatable on the bottom of a support and a side part that is locatable on the side of a support. In certain particular aspects, such a seal member has a top part that covers part of a top of a support.

In certain particular aspects, such a seal member is a single, integral piece with sides corresponding to sides of a screen support, the single piece stretchable to fit snugly around a screen support and provide sealing for all of its sides.

In other certain particular aspects, one or both ends of such a seal member include side and top portions to receive, hold, and/or protect part of a screen or screen support.

A vibratory separator or shale shaker, in one embodiment according to the present invention is, according to the present invention, provided with one, two, three or more screens as described herein according to the present invention. The present invention, in certain embodiments, includes a vibratory separator or shale shaker with a base or frame; a “basket” or screen mounting apparatus on or in the base or frame; one, two, three or more screens according to the present invention with seal members according to the present invention; vibrating apparatus; and a collection tank or receptacle. In one particular aspect, such a shale shaker treats drilling fluid contaminated with solids, e.g. cuttings, debris, etc.

The present invention discloses, in certain aspects, screens for a vibratory separator, the screens having: a support, the support having a support top, a support bottom, two spaced-apart support ends, and two spaced-apart support sides; screening material (one or more layers) on the support; a seal member encompassing the support; the seal member having two spaced-apart seal ends, each of the seal member's two spaced-apart seal ends in contact with one of the support's spaced apart support ends and the seal member having two spaced-apart seal sides, each of the seal member's two spaced-apart seal sides in contact with one of the support's two spaced-apart support sides; the seal member having a bottom part connected to the seal member's two spaced-apart seal ends and the two spaced-apart seal sides; the bottom part including a seal portion (e.g. either a hollow seal portion or a projection member projecting from the seal member ends and sides) for sealingly contacting a screen supporting structure of the vibratory separator for supporting the screen; and, in one aspect, the seal portion, in one aspect, extending around the entire perimeter of the support.

The present invention discloses, in certain aspects, a screen for a vibratory separator, the screen including: a support, the support having a support top, a support bottom, two spaced-apart support ends, and two spaced-apart support sides; screening material on the support; a seal member encompassing the support; the seal member having two spaced-apart seal ends, each of the seal member's two spaced-apart seal ends in contact with one of the support's spaced apart support ends and the seal member having two spaced-apart seal sides, each of the seal member's two spaced-apart seal sides in contact with one of the support's two spaced-apart support sides; the seal member having a bottom part connected to the seal member's two spaced-apart seal ends and the two spaced-apart seal sides; the bottom part having a seal portion for sealingly contacting a screen supporting structure of the vibratory separator for supporting the screen, and the bottom part of the seal member in contact with the support bottom of the support.

The present invention discloses, in certain aspects, methods for making a screen for use on a vibratory separator, the methods including: connecting screening material to a support, the support having an outer periphery; placing a seal member on the support encompassing the support's outer periphery, the seal member as any described herein according to the present invention; and locating a bottom part of the seal member in contact with a support bottom of the support.

The present invention discloses, in certain aspects, methods for screening material fed to a vibratory separator, the material including liquid and solids, the methods including: feeding material to a screen of a vibratory separator, the screen as any described herein according to the present invention; and with the screen, screening the material to separate solids from the liquid. In one aspect the vibratory separator is a shale shaker and the screen is for mounting on the shale shaker to screen solids from a drilling fluid mixture fed to the shale shaker.

Accordingly, the present invention includes features and advantages which are believed to enable it to advance vibrated screen technology. Characteristics and advantages of the present invention described above and additional features and benefits will be readily apparent to those skilled in the art upon consideration of the following detailed description of preferred embodiments and referring to the accompanying drawings.

What follows are some of, but not all, the objects of this invention. In addition to the specific objects stated below for at least certain preferred embodiments of the invention, other objects and purposes will be readily apparent to one of skill in this art who has the benefit of this invention's teachings and disclosures. It is, therefore, an object of at least certain preferred embodiments of the present invention to provide the embodiments and aspects listed above and:

New, useful, unique, efficient, nonobvious shale shakers and vibratory separators; screens for vibratory separators and shale shakers; seal members for such screens; and methods for using them to separate components of material to be treated thereby; in one aspect, systems for shale shakers for treating drilling fluid with solids therein; and

Such separators and shakers with one, two, three or more useful, unique, efficient, and nonobvious screens according to the present invention with seal members according to the present invention.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWING

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1A is a top view of a screen according to the present invention.

FIG. 1B is a bottom view of the screen of FIG. 1A.

FIG. 2A is a bottom view of a seal member according to the present invention of the screen of FIG. 1A.

FIG. 2B is a cross-section view of the seal member of the screen of FIG. 2A along line 2B-2B of FIG. 2A.

FIG. 2C is an partial perspective view of the seal member as shown in FIG. 2B.

FIG. 2D is a cross-section view along line 2D-2D of FIG. 1A.

FIG. 3 is a cross-section view of a seal member according to the present invention.

FIG. 4A is a top view of a screen according to the present invention.

FIG. 4B is a bottom view of the screen of FIG. 1A.

FIG. 5A is a top view of a seal member according to the present invention of the screen of FIG. 4A.

FIG. 5B is a cross-section view of the seal member of the screen of FIG. 4A along line 5B-5B of FIG. 5A.

FIG. 5C is an partial perspective view of the seal member as shown in FIG. 5B.

FIG. 5D is a cross-section view of the seal member of the screen of FIG. 5A along line 5D-5D of FIG. 5A.

FIG. 6 is a top view of a screen according to the present invention.

FIG. 7A is a top view of a seal member according to the present invention of the screen of FIG. 6.

FIG. 7B is a cross-section view of the seal member of the screen of FIG. 7A along line 7B-7B of FIG. 7A.

FIG. 7C is a cross-section view of the seal member of the screen of FIG. 7A along line 7C-7C of FIG. 7A.

FIG. 7D is a cross-section view of the seal member of the screen of FIG. 7A along line 7D-7D of FIG. 7A.

FIG. 8A is a top view of a screen according to the present invention.

FIG. 8B is a cross-section view along line 8B-8B of FIG. 8A of part of the screen of FIG. 8A showing a cross-section view of part of a seal member according to the present invention.

FIG. 8C is a cross-section view of an alternative embodiment of the screen and seal member of FIG. 8A.

FIG. 8D is a cross-section view of a seal member according to the present invention.

FIG. 9A is a perspective view of a screen according to the present invention.

FIG. 9B is a top view of the screen of FIG. 9A.

FIG. 9C is a side view of the screen of FIG. 9A.

FIG. 9D is an end view of the screen of FIG. 9A.

FIG. 9E is a cross-section view along line 9E-9E of FIG. 9D. FIG. 9F is a cross-section view along line 9F-9F of FIG. 9D.

Presently preferred embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. Like or identical reference numerals identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DETAILED DESCRIPTION OF THE INVENTION

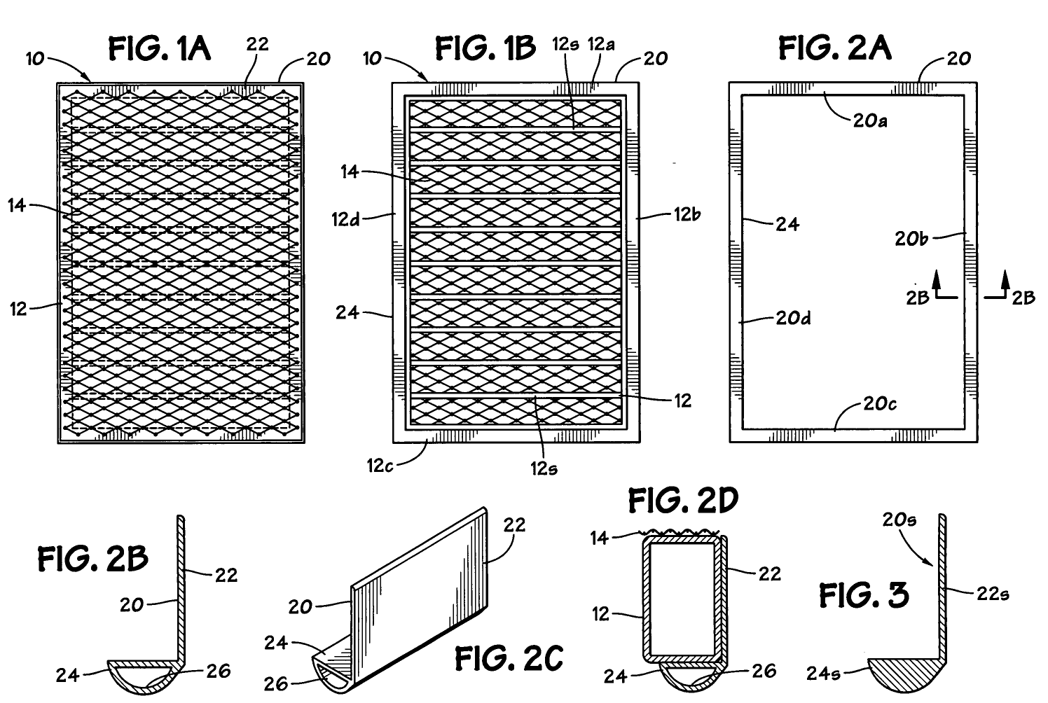

FIGS. 1A and 1B show a screen assembly 10 according to the present invention which has a frame (screen support) 12; screening material 12 on the frame; and a seal member 20 according to the present invention around the frame 12. As is true for any embodiment of the present invention, including, but not limited to those described in detail below, the screening material 14 (and any screening material described herein) can be any known layer or layers of screening material, mesh, wire, or cloth; connected together or not (welded, epoxied, glued, adhered, sintered) over some or all of a screen surface; with any known screen support-frame (solid, tubular, hollow, etc) perforated plate, strip support, etc.; with the screening material secured to the support in any known way. As is true for any embodiment of the present invention, a known material may be used for the screening material (e.g. but not limited to, stainless steel) and for the frame (e.g., but not limited to, steel); and any known sealing material may be used for the seal member 20 (and for any seal member according to the present invention), e.g., but not limited to, rubber, nitrile rubber, polyurethane, fiberglass, and stainless steel.

The frame 12 has four sides 12a, 12b, 12c, 12d and a plurality of spaced-apart crossmembers or strips 12s.

The seal member 20 has four sides 20a, 20b, 20c, 20d which correspond to the sides 12a-12d of the frame 12 and the sides 20a-20d of the seal member 20 are formed, located, and sized for a tight fit around the frame 12. The seal member 20 (as is true of any seal member according to the present invention) is secured to the frame 12 with a snug friction fit and/or with an adhesive such as epoxy, glue, acrylic glue or super glue. As is true for any seal member according to the present invention, the seal member 20 may be adhered to a screen's support and/or connected with a press fit.

As shown in FIGS. 2B and 2C, the seal member 20 has a side part 22 which extends all the way around the seal member 20 and which abuts the sides 12a-12d of the frame 12. Integral with the side part 22 is a lower seal 24 which, in this embodiment, is hollow with an interior space 26. In certain particular embodiments the seal member 20 is made of (nitrile rubber) and is flexible, with the seal 24 deformable by slight pressure thereon. The seal 24 extends all around the bottom of the frame 12 and, in certain aspects, is adhered to the bottom of the frame 12 with e.g., super glue. The interior space 26 is completely within the seal 24. As is true for any seal member according to the present invention, the seal like the seal 24 may be any desired shape with a space therein, and, in one particular embodiment, is generally “D” shaped as shown in FIG. 2B.

As shown in FIG. 2D (and as may be true for any embodiment herein), the side part 22 of the seal member 20 extends up to the top of the frame 12. It is to be understood it is within the scope of the present invention for the side part 22 (and for the side part of any embodiment herein) to extend only up to a certain point on a frame, e.g., but not limited to half-way up a frame side, a fourth of the way up, or three-fourths of the way up. The frame 12, shown in FIG. 2D as made of hollow tubulars, may, according to the present invention, be made of solid members.

As shown in FIG. 3, a seal member 20s, like the seal member 20, with a side part 22s, may, according to the present invention, have a solid seal 24s.

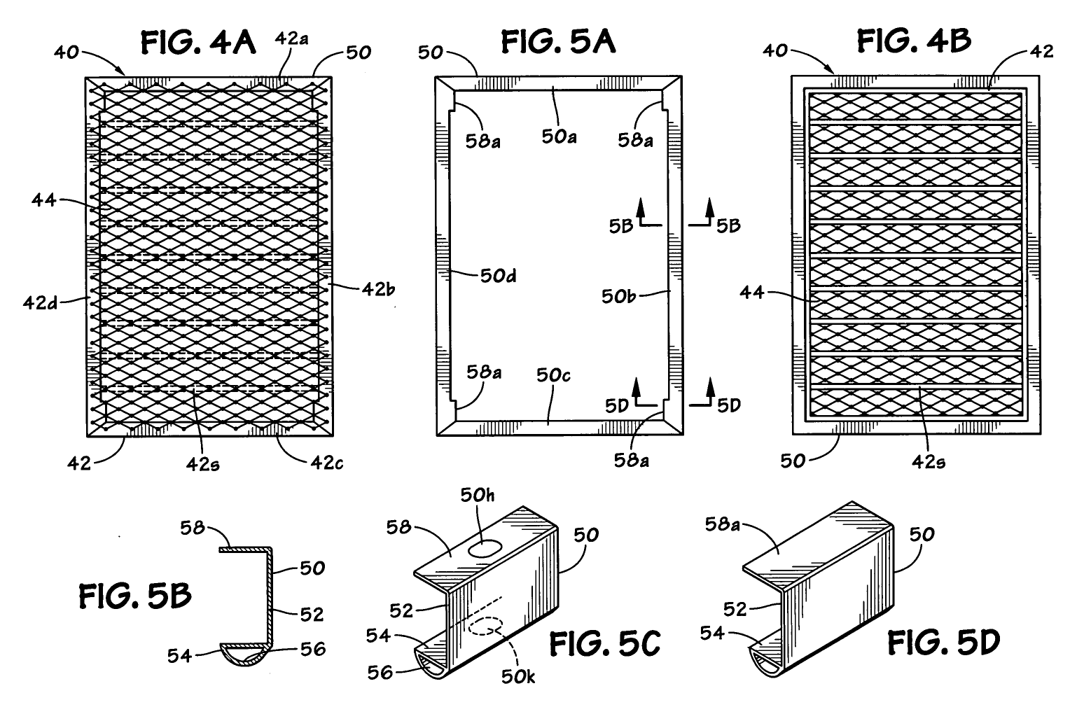

FIGS. 4A and 4B show a screen assembly 40 according to the present invention which has a frame 42, with a plurality of spaced-apart crossmembers or strips 42s, sides 42a, 42b, 42c, 42d, and a seal member 50. Screening material 44 is on the frame 42.

The seal member 50 has four sides, 50a, 50b, 50c, 50d, corresponding to and fitting around the four sides 42a-42d of the frame 42. As viewed from above in FIGS. 4A and 5A, the seal member 50 has a top part 58 which extends around the seal member 50 and which covers a portion of the top areas of the frame sides 42a-42d as well as parts of the screening material 44 (shown in dotted lines, FIG. 4A).

As shown in FIGS. 5A and 5D, the seal member, optionally, has parts 58a which are wider than parts 58. Optionally, and as may be true for any seal member according to the present invention, the seal member 50, as shown in FIG. 5C, can have one or more hole combinations 50h, 50k or only a single hole 50k to receive a pin projecting up from a screen deck or screen support.

The seal member 50 has a lower seal 54 with a hollow interior space 56. The sides 42a-42d of the frame 42 are received between the parts 58 (and 58a) and the seal 54, with a side part 52 of the seal member 50 abutting the exteriors of the sides 42a-42d.

FIG. 6 shows a screen 60 according to the present invention which has a frame 62 with sides 62a, 62b, 62c, 62d and spaced-apart crossmembers or strips 62s and screening material 64 thereon. A seal member 70 according to the present invention encompasses the frame 62.

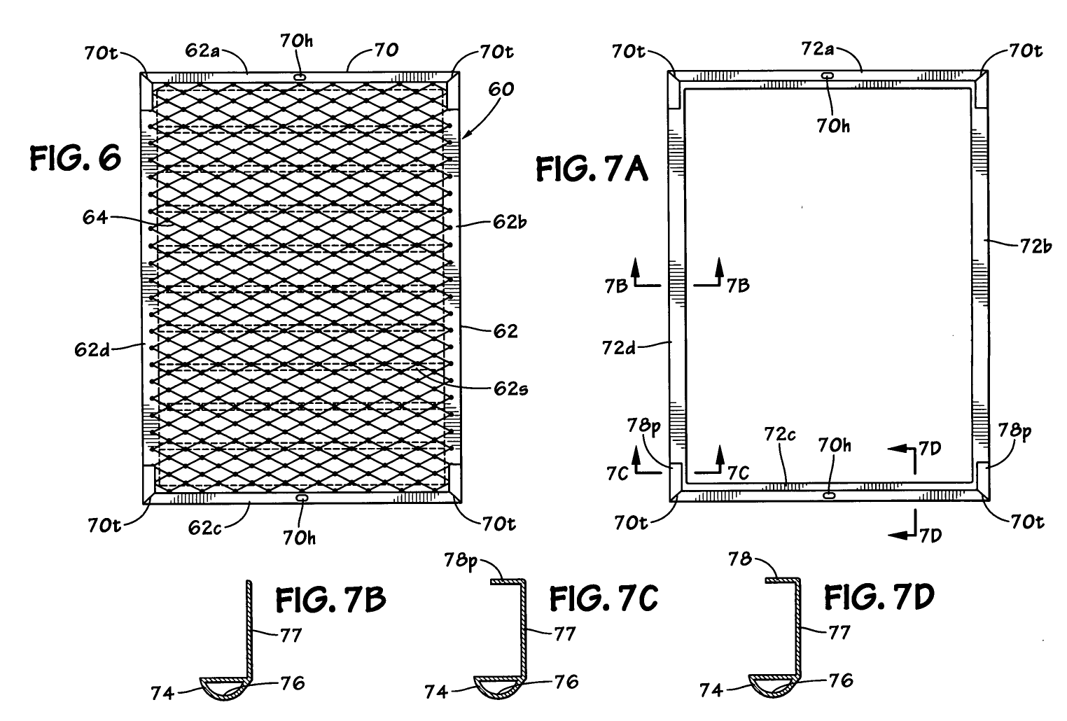

The seal member 70 has sides 72a, 72b, 72c, and 72d. A substantial portion of the sides 72b and 72d has no top part that extends from a side part 74 over part of the frame 62, as shown in the cross-section view of FIG. 7B. The sides 72a and 72c of the seal member 70 do have a top part 78 which extends from the seal member 70 and covers part of the top surface of the sides 62d and 62c of the frame 62. Small portions 78p of the top parts 78 extend over portions of the sides 72b and 72d; and thus sides 62a and 62c of the frame 62 are received with and abut the seal member's parts 74, 77 and 78. It is within the scope of the present invention, as is true for any embodiment herein, for the top parts 78 to cover wires of the screening material 64, or not. The portions 78p are optional. Optionally, slits 70t are cut in the corners of the seal member 70. As may be true for any seal member according to the present invention, the seal member 70 has holes 70h through the seal member to accommodate pins projecting up from a screen deck or screen support.

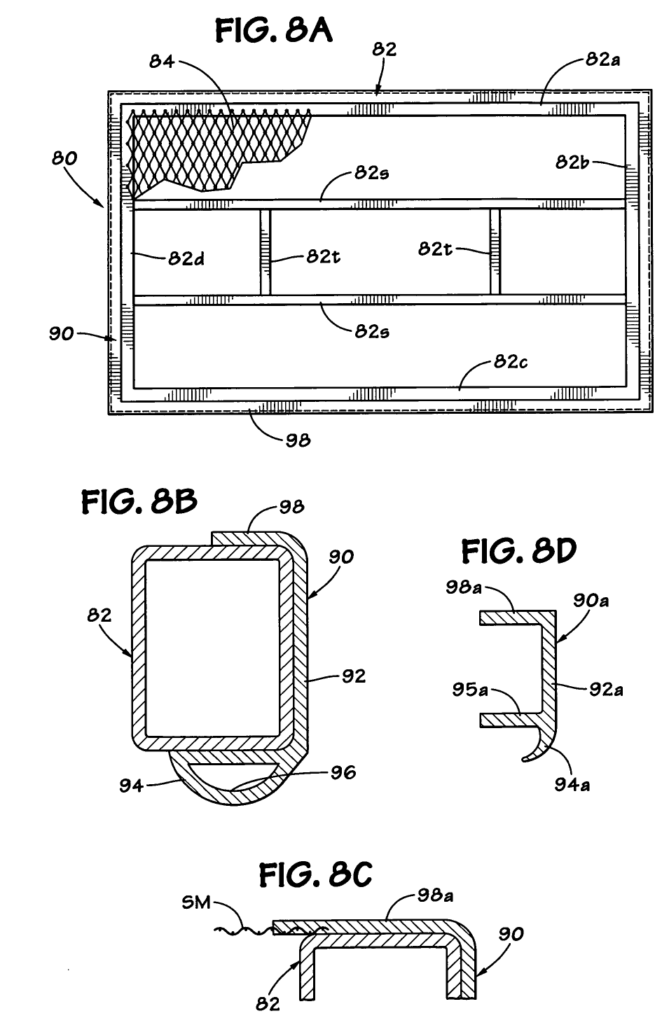

FIG. 8A shows a screen 80 according to the present invention which has a hollow tubular frame 82 with sides 82a, 82b, 82c, 82d and crossmembers 82s and 82t. Screening material 84 covers the frame 82 (although shown partially in FIG. 8A).

A seal member 90 encompasses the frame 82. A dotted line (FIG. 8A) shows the outer edge of the frame 82. Any seal member according to the present invention may be used with the screen 80.

The seal member 90 has a top part 98 which extends over a portion of the top surfaces of the sides 82a-82d and a side part 92 which extends around and abuts the side surfaces of the sides 82a-82d. The entire top surface of the tubular part shown in FIG. 8B may be covered by the seal member 90. Optionally, as shown in FIG. 8C (and as may be true for any seal member according to the present invention) the top part may be a top part 98a that extends past the frame 82 (beyond an inner surface of all frame ends and frame sides) and covers a portion of screening material SM on the frame 82. A lower seal 94 abuts lower surfaces of the sides 82a-82d. The lower seal, optionally, has a hollow interior space 96.

An optional embodiment of 90a of a seal member, according to the present invention, has a top part 98a which can extend over a portion of a top surface of sides of a frame and a side part 92a which can extend around and abut side surfaces of frame sides. A bottom member 95a can abut a bottom of a frame. A lower seal 94a can abut a lower surface of sides of a frame.

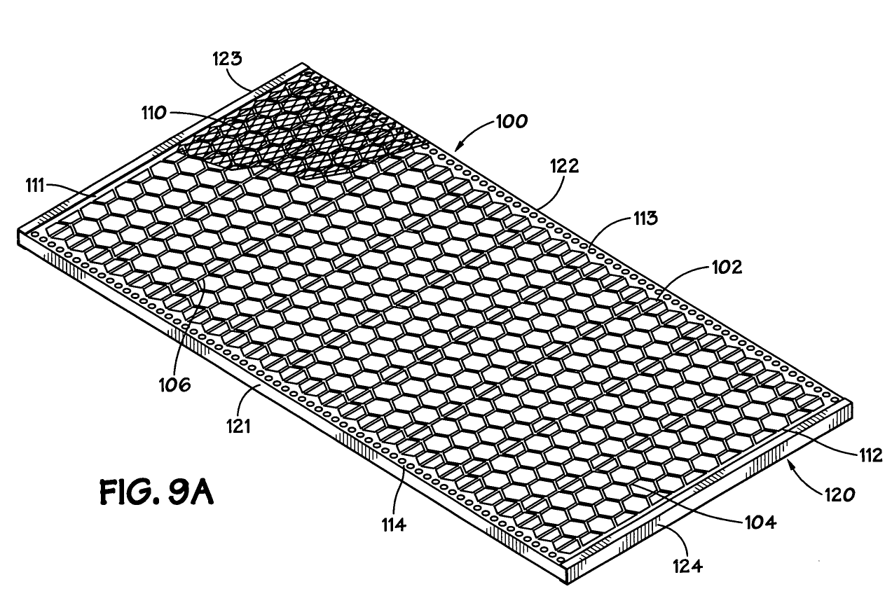

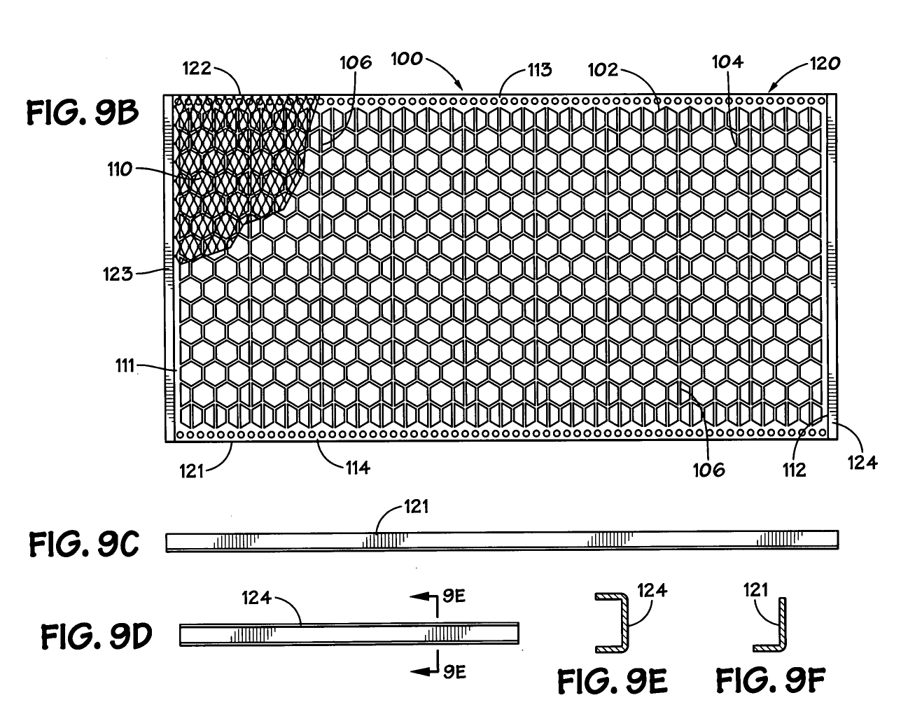

FIGS. 9A and 9B show a screen 100 according to the present invention which has a frame 102 with holes 104 therethrough and spaced-apart cross members 106. Screening material 110 (e.g. any screening material disclosed herein; shown partially and cut-away) covers the surface of the frame 102. The frame 102 has ends 111, 112 and sides 113, 114.

A seal member 120 according to the present invention encompasses the frame 102. The seal member 120 has sides 121, 122 which do not project above the top of the frame 102 and ends 123, 124 which are generally “C” shaped and receive and cover the ends 111, 112 of the frame 102.

The present invention, therefore, provides in at least certain embodiments, a screen for a vibratory separator, the screen including: a support, the support having a support top, a support bottom, two spaced-apart support ends, and two spaced-apart support sides; screening material on the support; a seal member encompassing the support; the seal member having two spaced-apart seal ends, each of the seal member's two spaced-apart seal ends in contact with one of the support's spaced apart support ends and the seal member having two spaced-apart seal sides, each of the seal member's two spaced-apart seal sides in contact with one of the support's two spaced-apart support sides; the seal member having a bottom part connected to the seal member's two spaced-apart seal ends and the two spaced-apart seal sides; the bottom part including a hollow seal portion for sealingly contacting a screen supporting structure of the vibratory separator for supporting the screen; and, in one aspect, the bottom part of the seal member in contact with the support bottom of the support. Such a screen may have one or some, in any possible combination, of the following: the seal member having a top part connected to each of the seal member's seal ends and seal sides, and the top part on the support top of the support; the bottom part having a bottom hole for receiving a projection of a screen supporting structure of a vibratory separator; the seal member having a top part connected to each of the seal member's seal ends and seal sides, the top part on the support top of the support, and the top part has a top hole for receiving a projection of a screen supporting structure of a vibratory separator that is projecting through the bottom hole; the hollow seal portion is generally “D” shaped; the top part covers portions of the screening material; the top part extends inwardly of the screen beyond an inner surface of each of the support ends and support sides; the vibratory separator is a shale shaker and the screen is for mounting on the shale shaker to screen solids from a drilling fluid mixture fed to the shale shaker; and/or the seal member having a plurality of sides, and a slit at each intersection of two sides of the plurality of sides.

The present invention, therefore, provides in at least certain embodiments, a method for making a screen for use on a vibratory separator, the method including: connecting screening material to a support, the support having an outer periphery; placing a seal member on the support encompassing the support's outer periphery, the seal member as any described herein according to the present invention; and locating a bottom part of the seal member in contact with a support bottom of the support. Such a method may have one or some, in any possible combination, of the following: the seal member having a plurality of sides, and a plurality of slits, a slit at each intersection of two sides of the plurality of sides; the seal member having a top part connected to each of the seal member's seal ends and seal sides, and the top part on the support top of the support; the bottom part has a bottom hole for receiving a projection of a screen supporting structure of a vibratory separator; the seal member having a top part connected to each of the seal member's seal ends and seal sides, the top part on the support top of the support, and the top part having a top hole for receiving a projection of a screen supporting structure of a vibratory separator that is projecting through the bottom hole; wherein the top part covers portions of the screening material; wherein the top part extends inwardly of the screen beyond an inner surface of each of the support ends and support sides.

The present invention, therefore, provides in at least certain embodiments, a method for screening material fed to a vibratory separator, the material including liquid and solids, the method including feeding material to a screen of a vibratory separator, the screen as any described herein according to the present invention; and with the screen, screening the material to separate solids from the liquid. Such a method may have one or some, in any possible combination, of the following: wherein the vibratory separator has at least one projection projecting upwardly beneath the screen, the screen bottom part having at least one hole for receiving the at least one projection, the method further including positioning the screen with the at least one projection in the at least one hole; and/or wherein the vibratory separator is a shale shaker and the screen is for mounting on the shale shaker to screen solids from a drilling fluid mixture fed to the shale shaker.

The present invention, therefore, provides in at least certain embodiments, a screen for a vibratory separator, the screen including: a support, the support having a support top, a support bottom, two spaced-apart support ends, and two spaced-apart support sides; screening material on the support; a seal member encompassing the support; the seal member having two spaced-apart seal ends, each of the seal member's two spaced-apart seal ends in contact with one of the support's spaced apart support ends and the seal member having two spaced-apart seal sides, each of the seal member's two spaced-apart seal sides in contact with one of the support's two spaced-apart support sides; the seal member having a bottom part connected to the seal member's two spaced-apart seal ends and the two spaced-apart seal sides; and the bottom member having a seal portion projecting therefrom for sealingly contacting a screen supporting structure of the vibratory separator for supporting the screen.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventors may rely on the Doctrine of Equivalents to determine and assess the scope of their invention and of the claims that follow as they may pertain to apparatus not materially departing from, but outside of, the literal scope of the invention as set forth in the following claims. All patents and applications identified herein are incorporated fully herein for all purposes. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A screen for a vibratory separator, the screen comprising
a support, the support having a support top, a support bottom, two spaced-apart support ends, and two spaced-apart support sides,
screening material on the support,
a seal member encompassing the support,
the seal member having two spaced-apart seal ends, each of the seal member's two spaced-apart seal ends in contact with one of the support's spaced apart support ends and the seal member having two spaced-apart seal sides, each of the seal member's two spaced-apart seal sides in contact with one of the support's two spaced-apart support sides,
the seal member having a bottom part connected to the seal member's two spaced-apart seal ends and the two spaced-apart seal sides,
the bottom part including a hollow seal portion for sealingly contacting a screen supporting structure of the vibratory separator for supporting the screen, and
the bottom part of the seal member in contact with the support bottom of the support.

2. The screen of claim 1 further comprising
the seal member having a top part connected to each of the seal member's seal ends and seal sides, and the top part on the support top of the support.

3. The screen of claim 1 wherein
the bottom part has a bottom hole for receiving a projection of a screen supporting structure of a vibratory separator.

4. The screen of claim 3 wherein
the seal member having a top part connected to each of the seal member's seal ends and seal sides,
the top part on the support top of the support, and
the top part has a top hole for receiving a projection of a screen supporting structure of a vibratory separator that is projecting through the bottom hole.

5. The screen of claim 1 wherein the hollow seal portion is generally “D” shaped.

6. The screen of claim 2 wherein the top part covers portions of the screening material.

7. The screen of claim 6 wherein the top part extends inwardly of the screen beyond an inner surface of each of the support ends and support sides.

8. The screen of claim 1 wherein the vibratory separator is a shale shaker and the screen is for mounting on the shale shaker to screen solids from a drilling fluid mixture fed to the shale shaker.

9. The screen of claim 1 wherein
the seal member has a plurality of sides, and
a slit at each intersection of two sides of the plurality of sides.

10. A screen for a vibratory separator, the screen comprising
a support, the support having a support top, a support bottom, two spaced-apart support ends, and two spaced-apart support sides,
screening material on the support,
a seal member encompassing the support,
the seal member having two spaced-apart seal ends, each of the seal member's two spaced-apart seal ends in contact with one of the support's spaced apart support ends and the seal member having two spaced-apart seal sides, each of the seal member's two spaced-apart seal sides in contact with one of the support's two spaced-apart support sides,
the seal member having a bottom part connected to the seal member's two spaced-apart seal ends and the two spaced-apart seal sides, and
the bottom part having a seal portion projecting therefrom for sealingly contacting a screen supporting structure of the vibratory separator for supporting the screen.

11. A method for making a screen for use on a vibratory separator, the method comprising
connecting screening material to a support, the support having an outer periphery,
placing a seal member on the support encompassing the support's outer periphery, the seal member comprising
the support,
the seal member having two spaced-apart seal ends, each of the seal member's two spaced-apart seal ends in contact with one of the support's spaced apart support ends and the seal member having two spaced-apart seal sides, each of the seal member's two spaced-apart seal sides in contact with one of the support's two spaced-apart support sides,
the seal member having a bottom part connected to the seal member's two spaced-apart seal ends and the two spaced-apart seal sides,
the bottom part including a hollow seal portion for sealingly contacting a screen supporting structure of the vibratory separator for supporting the screen, and
the bottom part of the seal member in contact with the support bottom of the support, and
locating the bottom part of the seal member in contact with the support bottom of the support.

12. The method of claim 11 wherein
the seal member has a plurality of sides, and
a plurality of slits, a slit at each intersection of two sides of the plurality of sides.

13. The method of claim 11 wherein the seal member has a top part connected to each of the seal member's seal ends and seal sides, the method further comprising
positioning the top part on the support top of the support,

14. The method of claim 11 further comprising
the bottom part has a bottom hole for receiving a projection of a screen supporting structure of a vibratory separator, the method further comprising
placing a projecting of the screen supporting structure in the bottom hole.

15. The method of claim 14 further comprising
the seal member having a top part connected to each of the seal member's seal ends and seal sides,
the top part on the support top of the support, and
the top part has a top hole for receiving a projection of a screen supporting structure of a vibratory separator that is projecting through the bottom hole, the method further comprising
placing the projection in the top hole.

16. The method of claim 11 further comprising
wherein the top part is sufficiently wide to cover portions of the screening material, the method further comprising
covering portions of the screening material with the top part.

17. The method of claim 11 further comprising
wherein the top part is sufficiently wide to extend inwardly of the screen beyond an inner surface of each of the support ends and support sides, the method further comprising
locating the top part so that the top part extends inwardly of inner surfaces of the support ends and support sides.

18. A method for screening material fed to a vibratory separator, the material including liquid and solids, the method comprising
feeding material to a screen of a vibratory separator, the screen comprising a support, the support having a support top, a support bottom, two spaced-apart support ends, and two spaced-apart support sides, screening material on the support, a seal member encompassing the support, the seal member having two spaced-apart seal ends, each of the seal member's two spaced-apart seal ends in contact with one of the support's spaced apart support ends and the seal member having two spaced-apart seal sides, each of the seal member's two spaced-apart seal sides in contact with one of the support's two spaced-apart support sides, the seal member having a bottom part connected to the seal member's two spaced-apart seal ends and the two spaced-apart seal sides, the bottom member having a hollow seal portion for sealingly contacting a screen supporting structure of the vibratory separator for supporting the screen, and the bottom part of the seal member in contact with the support bottom of the support, and
with the screen, screening the material to separate solids from the liquid.

19. The method of claim 18 wherein the vibratory separator has at least one projection projecting upwardly beneath the screen, the screen bottom part having at least one hole for receiving the at least one projection, the method further comprising
positioning the screen with the at least one projection in the at least one hole.

20. The method of claim 18 wherein the vibratory separator is a shale shaker and the screen is for mounting on the shale shaker to screen solids from a drilling fluid mixture fed to the shale shaker.
